(19) United States
(12) Patent Application Publication
(10) Pub. No.: US 2024/0266632 A1
(43) Pub. Date: Aug. 8, 2024

(54) FLAME-RESISTANT, COATED FABRIC INSULATOR

(71) Applicant: FEDERAL-MOGUL POWERTRAIN LLC, Northville, MI (US)

(72) Inventors: Jordan Zachary Boatwright, York, PA (US); Kamel Fennell, Plymouth Meeting, PA (US); Scott McFarland, Maumelle, AR (US); Zobar Hassan, Northville, MI (US); Gene Jung, Clifton, NJ (US); Hicham Rokni, Clifton, NJ (US); Shannon Notaro, Clifton, NJ (US)

(21) Appl. No.: 18/431,754

(22) Filed: Feb. 2, 2024

Related U.S. Application Data
(60) Provisional application No. 63/443,227, filed on Feb. 3, 2023.

(51) Int. Cl. H01M 10/653; H01M 10/658; H01M 50/204; H01M 50/293

(52) U.S. Cl. CPC H01M 10/653; H01M 10/658; H01M 50/204; H01M 50/293; H01M 2200/00

(57) ABSTRACT

A flexible thermal insulator having a fabric layer, a flame resistant outer coating bonded to an outer side of the fabric layer, and a pressure-sensitive adhesive layer bonded to an inner side of the fabric layer.

### CROSS-REFERENCE TO RELATED APPLICATION

This application claims the benefit of U.S. Provisional Application Ser. No. 63/443,227, filed Feb. 3, 2023, which is incorporated herein by reference in its entirety.

### BACKGROUND OF THE INVENTION

### 1. Technical Field

This invention relates generally to thermal insulators, and more particularly to thermal insulators for inhibiting flame propagation between and from cells of a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. As shown in FIGS. 2A-2C, a battery pack 12 and housing 14 thereof are shown having a fiberglass insulator between and about cells 16 of the battery pack 12. The fiberglass insulator can result in a thermal runaway condition originating in any one of the cells 16 of the battery pack 12, such that flame propagates from a single cell 16 (FIG. 2A) to multiple cells (FIG. 2C), in less than 10 minutes at a temperature of 1000° C.

It is desired to provide a thermal insulation that inhibits the propagation of flame between cells of a battery pack when exposed to a flame at a distance of about 25 mm for 10 minutes or more at a temperature of 1200° C.-1400° C.

### SUMMARY OF THE INVENTION

It is an object of the present disclosure to provide an insulator material for use with an electric vehicle battery pack that addresses at least the desire to inhibit the propagation of flame from and within the battery pack for 10 minutes or more at a temperature of 1200-1400° C.

It is a further object of the present disclosure to provide an insulator material for use with an electric vehicle battery pack that is flexible, lightweight, has a thin profile to minimize the amount of space occupied by the insulator material between cells of the battery pack and about cells of the battery pack.

It is a further object of the present disclosure to provide an insulator material for use with an electric vehicle battery pack that is economical in manufacture and in use.

In accordance with one aspect of the invention, the insulator material is provided as a coated fabric insulator having a fabric layer, a flame resistant outer coating bonded to an outer side of the fabric layer, and a pressure-sensitive adhesive layer bonded to an inner side of the fabric layer, wherein the fabric layer is sandwiched between the flame-resistant outer coating and the pressure-sensitive adhesive layer.

In accordance with another aspect of the invention, the fabric layer can be provided as a fabric woven with mineral yarns.

In accordance with another aspect of the invention, the mineral yarns of the woven fabric can be provided from at least one of silica multifilaments, fiberglass multifilaments, basalt multifilaments, and nomex multifilaments.

In accordance with another aspect of the invention, the woven fabric is provided having a fabric weight of about 30-40 oz/sq-yd.

In accordance with another aspect of the invention, a release layer is releasably bonded to the pressure-sensitive adhesive layer for removal to expose the pressure-sensitive adhesive layer for adhesion to a surface of the electric vehicle battery pack.

In accordance with another aspect of the invention, the pressure-sensitive adhesive is fire-resistant.

In accordance with another aspect of the invention, the pressure-sensitive adhesive is an acrylic adhesive.

In accordance with another aspect of the invention, the flame resistant outer coating is provided as a compound including a liquid silicone rubber (LSR) infused with a fire-resistant material.

In accordance with another aspect of the invention, the compound includes between about 5% by mass to 30% by mass of the fire-resistant material.

In accordance with another aspect of the invention, the fire-resistant material infused in the LSR is powdered mica.

In accordance with another aspect of the invention, the compound has about 15% powered mica by mass.

In accordance with another aspect of the invention, the flame resistant outer coating is cured.

In accordance with another aspect of the invention, the flame resistant outer coating has a thickness between about 0.5 to 1.0 mm.

In accordance with another aspect of the invention, the coated fabric insulator has a thickness between about 1.0 to 2.0 mm.

In accordance with another aspect of the invention, the coated fabric insulator has a maximum thickness of 2.0 mm.

In accordance with another aspect of the invention, an electric vehicle battery pack is provided. The electric vehicle battery pack includes a housing bounding a plurality of cells. Further, a coated fabric insulator is disposed between and/or about the plurality of cells. The coated fabric insulator includes a fabric layer, a flame resistant outer coating bonded to an outer side of the fabric layer, and a pressure-sensitive adhesive layer bonded to an inner side of the fabric layer, wherein the fabric layer is sandwiched between the flame-resistant outer coating and the pressure-sensitive adhesive layer.

In accordance with another aspect of the invention, a method of constructing an insulator material for use with an electric vehicle battery pack is provided. The method includes interlacing mineral yarn to form a fabric layer. Further, forming a compound by mixing a liquid silicone rubber (LSR) with a fire-resistant material, bonding the compound to an outer side of the fabric layer and curing the compound to form a flame-resistant outer coating. Further, bonding an adhesive to an inner side of the fabric layer, and protecting the adhesive with a release layer.

In accordance with another aspect of the invention, the method can further include infusing the compound on the fabric layer such that the compound fills interstices between the interlaced mineral yarns.

In accordance with another aspect of the invention, the method can further include providing the fire-resistant material in the compound as powdered mica.

In accordance with another aspect of the invention, the method further includes providing the powdered mica having a mass between about 5 to 30% of the compound.

In accordance with another aspect of the invention, the method can further include providing the powdered mica having a mass between about 15% of the compound.

In accordance with another aspect of the invention, the method further includes providing the flame-resistant outer coating having a thickness between about 0.5 mm to 1.0 mm.

In accordance with another aspect of the invention, the method further includes providing the insulator material having a maximum thickness of 2.0 mm.

In accordance with another aspect of the invention, the method can further include providing the pressure-sensitive adhesive as an acrylic adhesive.

In accordance with another aspect of the invention, the method further includes providing the pressure-sensitive adhesive having a peal strength of about 5N/25 mm under normal operating conditions.

In accordance with another aspect of the invention, the method further includes providing the fabric layer having a fabric weight between about 30 oz/sq-yd to 40 oz/sq-yd.

In accordance with another aspect of the invention, the method can further include forming the fabric layer in a weaving process.

In accordance with another aspect of the invention, the method can further include forming the fabric layer with at least one of silica multifilaments, fiberglass multifilaments, basalt multifilaments, and nomex multifilaments.

In accordance with another aspect of the invention, the method can further include forming the fabric layer entirely with silica multifilaments.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a multilayer thermal insulator constructed in accordance with an aspect of the invention;

FIGS. 2A-2C illustrate a schematic representation of an electric vehicle battery pack in accordance with prior art, without a coated fabric insulator in accordance with the disclosure, undergoing a thermal runaway condition with a flame propagating without hindrance from a location of flame initiation (FIG. 2A) throughout a plurality of cells of the battery pack (FIG. 2C);

FIGS. 3A-3C are views similar to FIGS. 2A-2C, with the electric vehicle battery pack including a coated fabric insulator constructed in accordance with an aspect of the disclosure, with the coated fabric insulator shown suppressing and inhibiting flame propagating from a location of a thermal runaway condition within a single cell (FIG. 3A) throughout the plurality of cells of the battery pack (FIG. 3C);

FIG. 4 is a schematic side view of a flexible thermal insulator in accordance with a non-limiting embodiment of the disclosure; and

FIG. 5 is a partially broken away, fragmentary perspective view of the flexible thermal insulator in accordance of FIG. 4.

### DETAILED DESCRIPTION OF PREFERRED EMBODIMENTS

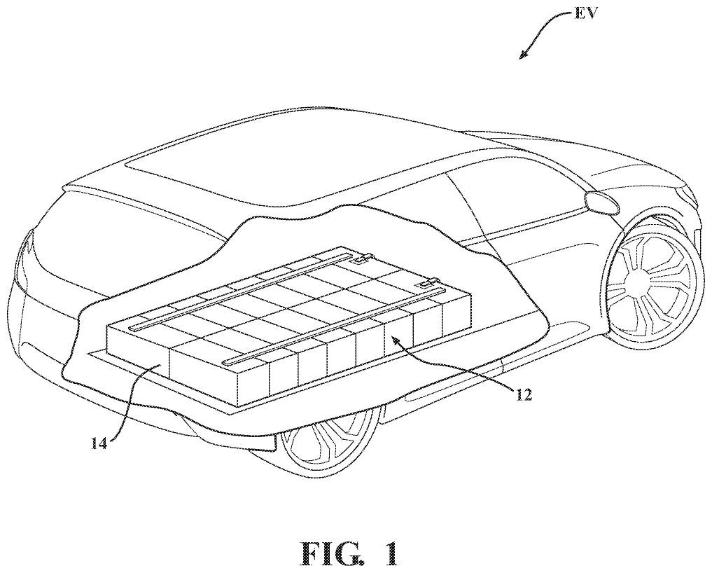

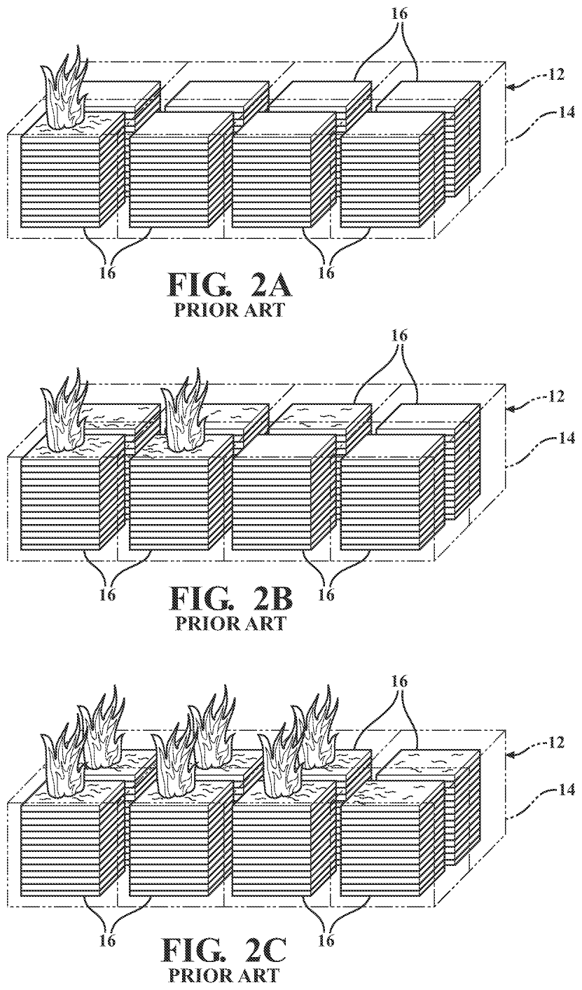

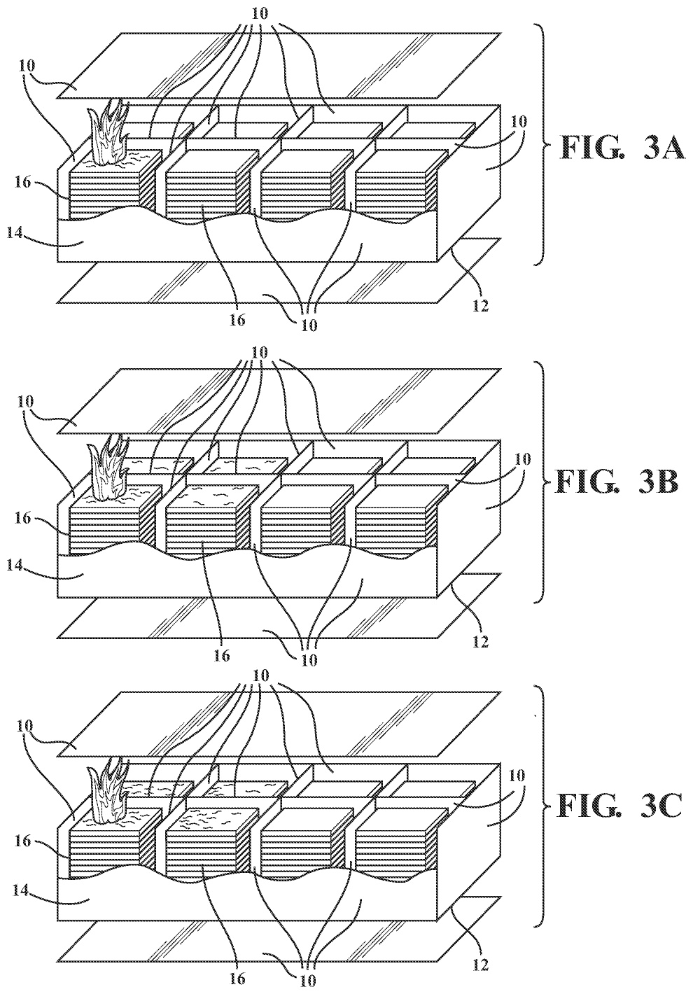

Referring in more detail to the drawings, FIG. 1 illustrates a motor vehicle, shown as an electrically powered motor vehicle, also referred to as electric vehicle EV, having a battery pack 12, such as a lithium-ion battery pack, by way of example and without limitation, configured with an insulator material, also referred to as coated fabric insulator or flexible thermal insulator 10, in accordance with an aspect of the invention. The electric vehicle battery pack 12 includes a housing member, also referred to as casing or housing 14, bounding a plurality of cells 16, and including bus-bars interconnecting cells, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having a multilayer thermal insulator 10 as disclosed herein, whereat flame propagation can result, as shown in FIGS. 2A-2C, a thermal runaway condition originating in any one of the cells 16 of a battery pack 12, with the multilayer thermal insulator 10 being disposed between and/or about the cells 16, is controlled and contained via the multilayer thermal insulator 10, as illustrated in FIGS. 3A-3C, such that flame propagation is prevented for at least 10 minutes at an internal cell temperature ranging between 1200-1400° C., and an outer surface temperature of the battery housing 14, also referred to as case, is maintained to be less than 400° C., and preferably 370° C., for at least 10 minutes. The flexible thermal insulator 10 can withstand 2000 V dielectric conditions prior to and after exposure to flame for 10 minutes, and has a tensile strength of no less than 200 N/cm.

As shown schematically in FIGS. 3A-3C, the thermal insulator(s) 10, which can be arranged between adjacent cells 16 to thermally isolate the cells 16 from one another, as well as to shield and protect surfaces of the battery pack housing 14, the aforementioned bus-bars, high voltage electrical connectors, cell interfaces, low voltage signal wires, high voltage cables and cooling tubes against extreme temperature thermal runaway conditions and contamination, such as from fluid or debris, as well as from impact forces, such as may be experienced in a crash condition, is provided as a relatively thin, flexible composite wall 18, such as being no greater than 2.0 mm in thickness. The wall 18, being thin and flexible, can be configured as needed, such as by being able to be wrapped into a hollow tubular sleeve configuration about bus bars, wires, tubes, connectors and the like, and can also be used in sheet form, such as a flat planar sheet, to provide a protective outer barrier about an outer periphery of the cells 16, as well as to provide a protective barrier between adjacent cells 16 to effectively thermally isolate each cell 16 from an adjacent cell 16.

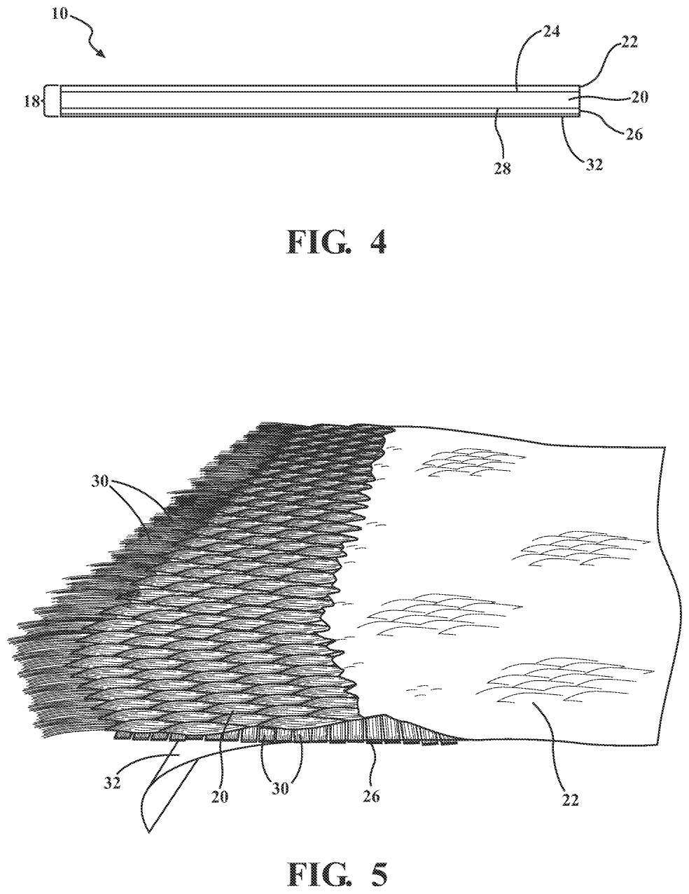

The composite wall 18, as shown schematically in FIG. 4 and photographically in FIG. 5, includes a fabric layer 20, a flame resistant outer coating 22 bonded to an outer surface, also referred to as outer side 24, of the fabric layer 20, and a pressure-sensitive adhesive layer 26 bonded to an inner surface, also referred to as inner side 28, of the fabric layer 20. As such, the fabric layer 20 is sandwiched between the flame-resistant outer coating 22 and the pressure-sensitive adhesive layer 26.

The fabric layer 20 is provided as a textile layer, such as via a fabric woven with mineral yarns 30. The fabric is woven having a tight weave pattern to enhance flame-resistance, such as via a plain weave pattern, by way of example and without limitation, and having a fabric weight between about 30 oz/sq-yd to 40 oz/sq-yd. The mineral yarns 30 of the woven fabric 20 can be provided from at least one of silica multifilaments, fiberglass multifilaments, basalt multifilaments, and nomex multifilaments, by way of example and without limitation.

The pressure-sensitive adhesive layer 26 is fire-resistant, and in one preferred embodiment, is provided as an acrylic adhesive. A release layer 32 is releasably bonded to a side of the pressure-sensitive adhesive layer 26 facing away from the fabric layer 20 for selective removal to expose the underlying pressure-sensitive adhesive layer 26 for adhesion to a desired surface of the electric vehicle battery pack 12. The pressure-sensitive adhesive layer 26 provides a minimum peal strength of 5 N/25 mm under normal operating conditions.

The flame-resistant outer coating 22, shown broken away in FIG. 5 solely for illustration of the underlying fabric layer 20, is provided as a compound including a liquid silicone rubber (LSR) infused with a fire-resistant material. In accordance an aspect of the disclosure, the fire-resistant material infused into the LSR is powdered mica. The flame-resistant outer coating 22 includes between about 5 to 30% by mass of the fire-resistant material. In accordance with one exemplary embodiment, the flame-resistant outer coating 22 has between about 10 to 20% by mass of powdered mica, and more particularly, about 15% powered mica by mass. The flame resistant outer coating 22 is cured after being bonded to the fabric layer 20. The flame resistant outer coating 22 has a thickness between about 0.5 to 1.0 mm. The flame-resistant outer coating 22 can be bonded in flush or overlying relation with an outer periphery of the fabric layer 20, thereby enhancing flame-resistance, as well as resistance to fabric end fray, such that no filaments of the fabric layer 20 extend more than 5 mm beyond an outer periphery of the flexible thermal insulator 10.

In accordance with another aspect of the invention, an electric vehicle battery pack 12 is provided. The electric vehicle battery pack 12 includes a housing 14 bounding a plurality of cells 16. Further, a coated fabric insulator 10 is disposed between and/or about the plurality of cells 16. The coated fabric insulator 10 includes a fabric layer 20, a flame resistant outer coating 22 bonded to an outer side 24 of the fabric layer 20, and a pressure-sensitive adhesive layer 26 bonded to an inner side 28 of the fabric layer 20, such that the fabric layer 20 is sandwiched between the flame-resistant outer coating 22 and the pressure-sensitive adhesive layer 26. The flame-resistant outer coating 22 is provided as a compound including between about 5 to 30% by mass powdered mica. The powdered mica is infused in the base material of the compound, such as liquid silicone rubber (LSR).

In accordance with another aspect of the invention, a method of constructing an insulator material 10 for use with an electric vehicle battery pack 12 is provided. The method includes interlacing mineral yarn 30 to form a fabric layer 20. Further, forming a compound by mixing a liquid silicone rubber (LSR) with a fire-resistant material, bonding the compound to an outer surface, also referred to as outer side 24, of the fabric layer 20 and curing the compound to form a flame-resistant outer coating 22. Further, bonding an adhesive 26 to an inner surface, also referred to as inner side 28, of the fabric layer 20, and protecting the adhesive 26 with a release layer 32, until desired to expose the adhesive for adhesion to a desired surface via removal of the release layer 32.

In accordance with another aspect of the invention, the method can further include infusing the compound on the fabric layer 20 such that the compound fills interstices between the interlaced mineral yarns 30.

The method further includes providing the fire-resistant material in the compound as powdered mica having a mass between about 5 to 30% of the mass of the compound.

In accordance with another aspect of the invention, in one exemplary embodiment, the method can further include providing the powdered mica having a mass of about 15% of the mass of the compound.

In accordance with another aspect of the invention, the method further includes providing the flame-resistant outer coating having a thickness between about 0.5 to 1.0 mm.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible thermal insulator for an electric vehicle battery pack, comprising:
a fabric layer;
a flame resistant outer coating bonded to an outer side of the fabric layer; and
a pressure-sensitive adhesive layer bonded to an inner side of the fabric layer, wherein the fabric layer is sandwiched between the flame-resistant outer coating and the pressure-sensitive adhesive layer.

2. The flexible thermal insulator of claim 1, wherein the fabric layer includes woven mineral yarns.

3. The flexible thermal insulator of claim 2, wherein the mineral yarns include at least one of silica multifilaments, fiberglass multifilaments, basalt multifilaments, and nomex multifilaments.

4. The flexible thermal insulator of claim 2, wherein the fabric layer is woven having a fabric weight between about 30 oz/sq-yd to 40 oz/sq-yd.

5. The flexible thermal insulator of claim 1, further including a release layer releasably bonded to the pressure-sensitive adhesive layer for removal to expose the pressure-sensitive adhesive layer for adhesion to a surface of the electric vehicle battery pack.

6. The flexible thermal insulator of claim 1, wherein the pressure-sensitive adhesive is fire-resistant.

7. The flexible thermal insulator of claim 6, wherein the pressure-sensitive adhesive is an acrylic adhesive.

8. The flexible thermal insulator of any one of claim 1, wherein the flame resistant outer coating is a compound including liquid silicone rubber (LSR) infused with a fire-resistant material.

9. The flexible thermal insulator of claim 8, wherein the compound includes between about 5 to 30% by mass of the fire-resistant material.

10. The flexible thermal insulator of claim 9, wherein the fire-resistant material is powdered mica.

11. The flexible thermal insulator of claim 10, wherein the compound includes about 15% by mass of the powdered mica.

12. The flexible thermal insulator of claim 1, wherein the flame resistant outer coating is cured.

13. The flexible thermal insulator of claim 1, wherein the flame resistant outer coating has a thickness between about 0.5 mm to 1.0 mm.

14. The flexible thermal insulator of claim 1, wherein the flexible thermal insulator has a thickness between about 1.0 mm to 2.0 mm.

15. An electric vehicle battery pack, comprising:
a housing;
a plurality of cells bounded by said housing; and
a flexible thermal insulator fixed to at least one surface of the housing, the flexible thermal insulator having:
a fabric layer;
a flame resistant outer coating bonded to an outer side of the fabric layer; and
a pressure-sensitive adhesive layer bonded to an inner side of the fabric layer, wherein the fabric layer is sandwiched between the flame-resistant outer coating and the pressure-sensitive adhesive layer.

16. The electric vehicle battery pack of claim 15, wherein the flame resistant outer coating is a compound including liquid silicone rubber (LSR) infused with a fire-resistant material.

17. The electric vehicle battery pack of claim 16, wherein the flame resistant outer coating is cured.

18. The electric vehicle battery pack of claim 17, wherein the fire-resistant material is powdered mica.

19. The electric vehicle battery pack of claim 18, wherein the compound includes between about 5 to 30% by mass of the powdered mica.

20. The electric vehicle battery pack of claim 15, wherein the fabric layer includes mineral yarns woven having a fabric weight between about 30 oz/sq-yd to 40 oz/sq-yd.
